(19) United States
(12) Patent Application Publication
(10) Pub. No.: US 2013/0121541 A1
(43) Pub. Date: May 16, 2013

(54) Method And Apparatus To Authenticate User

(71) Applicant: Dong-chul Hwang, Nam-gu (KR)

(72) Inventor: Dong-chul Hwang, Nam-gu (KR)

(73) Assignee: SAMSUNG ELECTRONICS CO., LTD., Suwon-si (KR)

(21) Appl. No.: 13/629,817

(22) Filed: Sep. 28, 2012

(30) Foreign Application Priority Data
Nov. 10, 2011 (KR) 10-2011-0117164

(51) Int. Cl. G06K 9/00

(52) U.S. Cl. 382/118

(57) ABSTRACT

A method of authenticating a user of a second device connected to a first device peer-to-peer (P2P) on a network, the method including receiving real-time image information containing a face of the user of the second device from the second device, displaying the received real-time image information on a screen of the first device, receiving user authentication information to determine whether the user of the second device is authenticated with reference to the displayed real-time image information, from a user of the first device, and authenticating the user of the second device, based on the received user authentication information.

### CROSS-REFERENCE TO RELATED PATENT APPLICATION

This application claims priority under 35 U.S.C. §119 from Korean Patent Application No. 10-2011-0117164, filed on Nov. 10, 2011, in the Korean Intellectual Property Office, the disclosure of which is incorporated herein by reference in its entirety.

### BACKGROUND

1. Field

The present general inventive concept relates to a method and apparatus to authenticate a user of a device connected via a peer-to-peer (P2P) network by identifying the user in a network environment without including a server.

2. Description of the Related Art

As wireless apparatuses and systems have been developing in complexity and usability, technologies such as a software enabled access point (Soft-AP) have been introduced, and thus methods of connecting a device to another device directly without going through a server have been developed. When devices are connected to each other directly, an authentication method cannot be performed in a server.

However, during formation of a wireless peer-to-peer (P2P) network, wireless local area network (WLAN) devices are connected peer-to-peer due to peer-to-peer architecture, rather than being connected by a fixed access point (AP), and it is difficult to ensure a reliable independent server to both the devices. Thus, it is difficult to trust an authentication result without an authentication management server that is reliable to both devices during connection therebetween and contains a database related to user authentication.

Accordingly, in order to overcome issues of authentication, a method of identifying a user using a real-time image when devices are connected directly via a peer-to-peer network without requiring an infrastructure such as a server or an AP is desirable.

### SUMMARY

The present general inventive concept provides a method and apparatus to authenticate a user of a device connected via a peer-to-peer (P2P) network to other devices.

The present general inventive concept also provides a computer readable recording medium having recorded thereon a program to execute the above method of authenticating a user of a device connected via a peer-to-peer (P2P) network to other devices.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a method of authenticating a user of a second device connected to a first device peer-to-peer (P2P) on a network, the method including receiving real-time image information containing a face of the user of the second device, from the second device, displaying the received real-time image information on a screen of the first device, receiving user authentication information to determine whether the user of the second device is authenticated with reference to the displayed real-time image information, from a user of the first device, and authenticating the user of the second device, based on the received user authentication information.

The method may further include obtaining real-time image information containing a face of the user of the first device, and transmitting the obtained real-time image information to the second device, wherein the displaying includes displaying the real-time image information and the obtained real-time image information.

The first device may be connected to at least one device, and the second device may be any one of devices connected to the first device.

The real-time image information of the second device may be received by using a streaming method.

The first device may be connected to the second device by using a software enabled access point (Soft-AP).

The method may further include transmitting and receiving a file based on the authenticating.

The foregoing and/or other features and utilities of the present general inventive concept may also be achieved by providing a first device connected to a second device peer-to-peer (P2P) on a network, the first device including a communication unit to receive from the second device real-time image information containing a face of a user of the second device, a display unit to display the received real-time image information, an input unit to receive from a user of the first device user authentication information to determine whether the user of the second device is authenticated with reference to the displayed real-time image information, and a user authentication unit to authenticate the user of the second device, based on the received user authentication information.

The first device may further include an imaging unit to obtain real-time image information containing a face of a user of the first device, wherein the communication unit may transmit the obtained real-time image information to the second device, and the display unit may simultaneously display the received real-time image information and the obtained real-time image information.

The first device may be connectable to at least one device, and the second device may be one connected to the first device.

The real-time image information of the second device may be received by using a streaming method.

The first device may be connected to the second device by using a software enabled access point (Soft-AP).

The first device may further include a storage unit to manage receipt and transmission of a file, based on the authenticating.

The foregoing and/or other features and utilities of the present general inventive concept may also be achieved by providing a mutual authentication method of a user of a first device and a user of a second device that are connected peer-to-peer (P2P) through a connection channel on a network, the mutual authentication method including obtaining real-time image information of the user of the first device and transmitting the obtained real-time image information to the second device, receiving real-time image information of the second device, from the second device, simultaneously displaying the received real-time image information and the obtained real-time image information, receiving user authentication information for determining whether the user of the second device is authenticated based on the displayed real-time image information, receiving user authentication information to determine whether the user of the first device is authenticated, from the second device; and performing mutual authentication, based on the received user authentication information and the received user authentication information.

The foregoing and/or other features and utilities of the present general inventive concept may also be achieved by providing a non-transitory computer readable recording medium having recorded thereon a program to execute a method of authenticating a user of a second device connected to a first device peer-to-peer (P2P) on a network, the method including receiving from the second device real-time image information containing a face of the user of the second device, displaying the received real-time image information on a screen of the first device, receiving from a user of the first device user authentication information to determine whether the user of the second device is authenticated with reference to the displayed real-time image information, and authenticating the user of the second device, based on the received user authentication information.

The foregoing and/or other features and utilities of the present general inventive concept may also be achieved by providing a non-transitory computer readable recording medium having recorded thereon a program to execute a mutual authentication method of a user of a first device and a user of a second device that are connected peer-to-peer (P2P) through a connection channel on a network, the mutual authentication method including obtaining real-time image information of the user of the first device and transmitting the obtained real-time image information to the second device, receiving from the second device real-time image information of the second device, simultaneously displaying the received real-time image information and the obtained real-time image information, receiving user authentication information to determine whether the user of the second device is authenticated based on the displayed real-time image information, receiving from the second device user authentication information to determine whether the user of the first device is authenticated, and performing mutual authentication, based on the received user authentication information and the received user authentication information.

The foregoing and/or other features and utilities of the present general inventive concept may also be achieved by providing a peer-to-peer (P2P) network device connectable to one or more devices, including a communication unit to receive real-time image information from the one or more devices, a display unit to display the received real-time image information, and a user authentication unit to authenticate a user corresponding one or more devices based on the received real-time image information.

Each device may further include an input unit to receive user authentication information from the user based on whether the received real-time image information authenticated.

The display unit may display real time image information corresponding to the user simultaneously with the real-time image information corresponding to another user.

Each device may further include an imaging unit to obtain the real-time image information corresponding to the user using the respective device, such that the communication unit transmits the obtained real-time image information to another of the plurality of devices.

The communication unit may communicate with the one or more devices such that the one or more devices takes a real-time user image to be transferred to the communication unit.

Each device may include one of a computer apparatus, a laptop computer, a mobile device, and a touchpad.

The real-time image information may correspond to an image of at least a portion of the user.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram of a user authentication apparatus according to an exemplary embodiment of the present general inventive concept;

FIG. 2 is a block diagram illustrating a first device to receive real-time image information of a user of a second device and to authenticate the user of the second device, according to an exemplary embodiment of the present general inventive concept;

FIG. 3 is a structural diagram illustrating a method of performing user authentication on a plurality of devices connected to a first device, according to an exemplary embodiment of the present general inventive concept;

FIG. 4A is a diagram illustrating real-time image information received from a plurality of devices being displayed on a display unit, according to an exemplary embodiment of the present general inventive concept;

FIG. 4B is a diagram illustrating real-time image information received from a plurality of devices being displayed on a display unit, according to another exemplary embodiment of the present general inventive concept;

FIG. 5 is a flowchart of a user authentication method according to an exemplary embodiment of the present general inventive concept; and

FIG. 6 is a diagram illustrating mutual authentication as a user authentication method, according to another exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

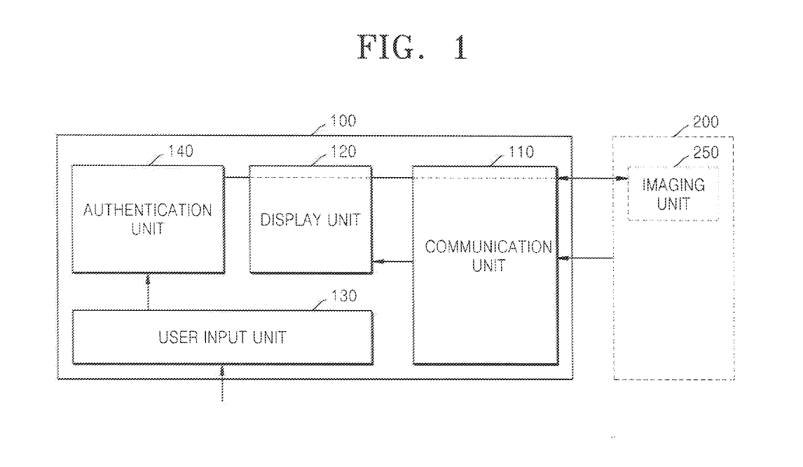

FIG. 1 is a block diagram of a user authentication apparatus according to an exemplary embodiment of the present general inventive concept.

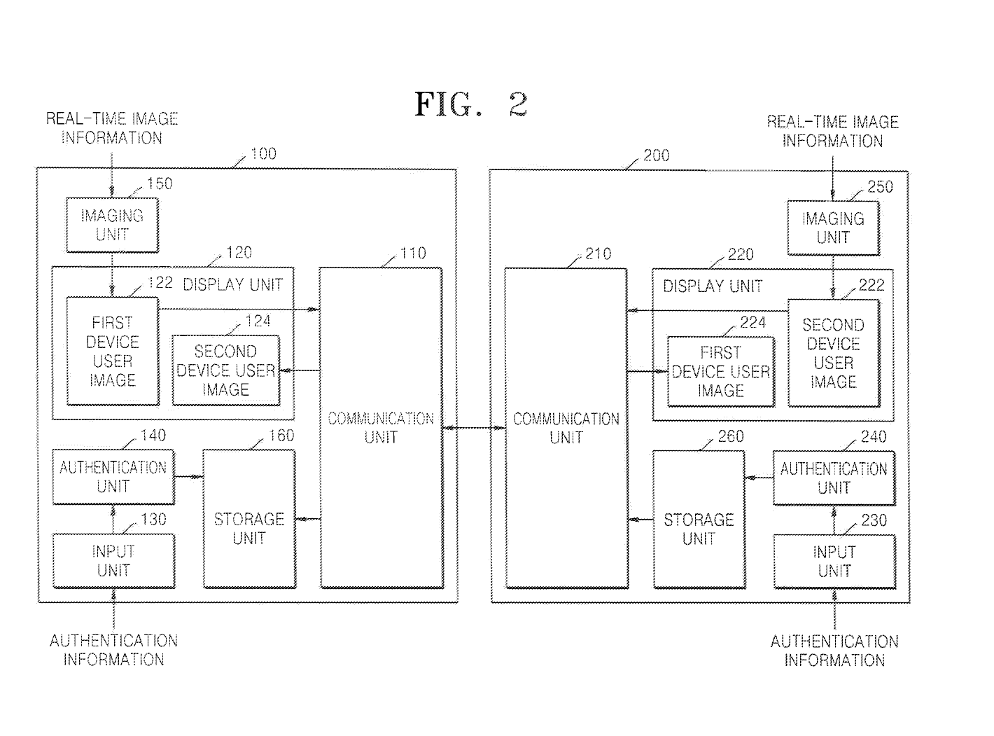

Referring to FIG. 1, a first device 100 includes a communication unit 110, a display unit 120, a user input unit 130, and an authentication unit 140. The first device 100 may include, but is not limited to, a personal computer (PC), a notebook computer, a smart phone, a tablet PC, etc. The first device 100 may include an imaging unit 150, as illustrated in FIG. 2, to transmit and capture an image in real time. A second device 200 may also include an imaging unit 250. The first device 100 receives real-time image information from the second device 200. The received real-time image information is displayed on the display unit 120 of the first device 100. The user input unit 130 of the first device 100 receives authentication information to determine whether a user of the second device 200 is authenticated, from a user of the first device 100. The authentication unit 140 completely authenticates the user of the second device 200, based on the authentication information. Hereinafter, a case where the first device 100 and the second device 200 are each a computer apparatus will be described, but the present embodiment is not limited thereto.

The communication unit 110 enables the first device 100 to connect to the second device 200 through a network. According to the embodiment of FIG. 1, examples of a network connection may include a wired network using a local area network (LAN), a wireless network using wireless fidelity (Wi-Fi) or similar wireless networks, Bluetooth®, P2P, or combinations thereof, but the present general inventive concept is not limited thereto. Thus, various network connection environments such as Ethernet, Intranet, etc., may be utilized.

The communication unit 110 of FIG. 1 receives the real-time image information of the user of the second device 200 that is connected to the first device 100 through a network. For example, the real-time image information of the user of the second device 200 may contain an image of a face of the user of the second device 200. The real-time image information may be obtained from the imaging unit 250 of the second device 200. Also, real-time image information of the user of the first device 100 may be obtained from the imaging unit 150, to perform mutual authentication, as illustrated in FIG. 2.

Since the communication unit 110 of FIG. 1 may receive the real-time image information from the second device 200, the real-time image information may be received by using a real-time streaming method. The first device 100 may be connected to the second device 200 by using Wi-Fi. In this case, when the streaming method is used, real-time image information may be effectively transmitted. When image information is received by using the streaming method, even before all data of the image information is received, the image information may be displayed by an application (e.g., a web browser, a plug-in, or any other moving-picture driving program) of a device. In order to use the streaming method, a device receiving data needs to collect data and to transmit data to the above-described application. Thus, in order to stably transmit and receive a moving picture that is captured by a webcam, a camera built into a mobile device, a smart phone, or any other type of picture transmission device, the streaming method may be used. In addition, authentication may be effectively performed by stably receiving a real-time image of a user of a device to be authenticated by using the above-described method.

That is, if a built network environment is not sufficient to transmit image information in real time, a real-time image may not be sufficiently transmitted or image reproduction may be repeatedly stopped. In such a built network environment, since a user as the other party may not be identified or image information is not reliable, the above-described problem may be overcome by transmitting real-time image information to the communication unit 110 by using the streaming method.

The term “real-time” may include a time during a connection between the first device 100 and the second device 200, or upon a request from the first device 100 for a connection to the second device 200. Also, a real-time image may include an image taken by the second device 200 as it is connected to the first device 100, an image that is requested from the first device 100 and then subsequently transmitted from the second device 200 to the first device 100, or an image taken by the second device 200 and transmitted to the first device 100 within a predetermined time. To create the real-time image, the image may be captured by the imaging unit 250 of the second device 200. An image taken previously is not definable as a real-time image.

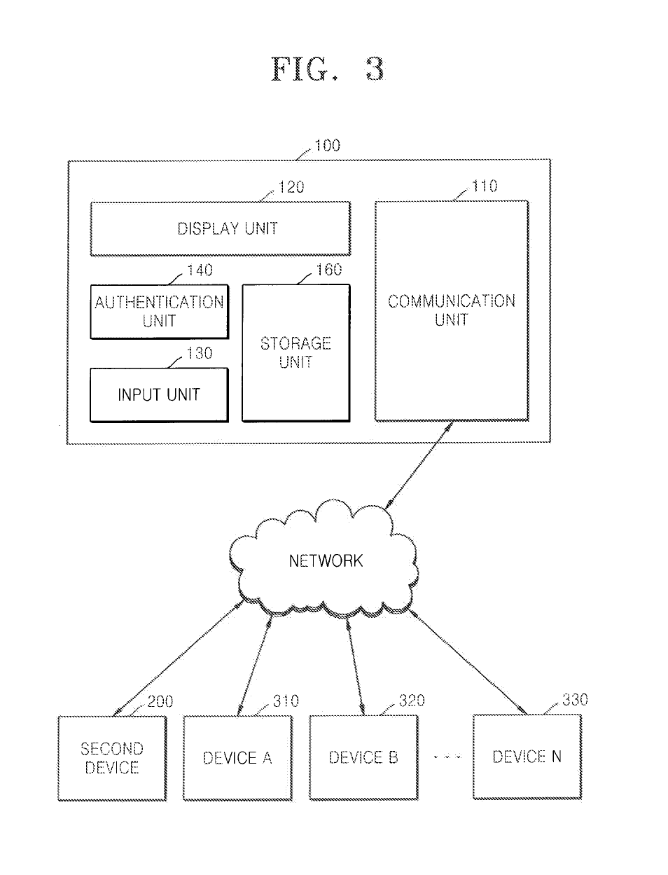

According to FIG. 1, the communication unit 110 connects the first device 100 to the second device 200. Alternatively, the communication unit 110 may connect the first device 100 to at least one other device or a plurality of other devices. For example, the communication unit 110 of the first device 100 may set a channel to connect at least one device or may receive real-time image information of a device connected through the set channel. In addition, a plurality of devices may be interconnected to each other through a channel that is set in a communication unit of any one device from among the devices, and real-time image information of each of the devices may be transmitted and received through the set channel, as illustrated in FIG. 3.

The display unit 120 may display the real-time information received from the second device 200. The real-time information may contain audio information such as audio data as well as video information. In addition, the display unit 120 may display the real-time information together with at least one piece of additional information to be displayed on a display screen. For example, while displaying the real-time information of the user of the second device 200 to be authenticated, the display unit 120 may simultaneously display a device profile, a user profile, a connection Internet protocol (IP), and positional information such as global positioning system (GPS) coordinate, but is not limited thereto.

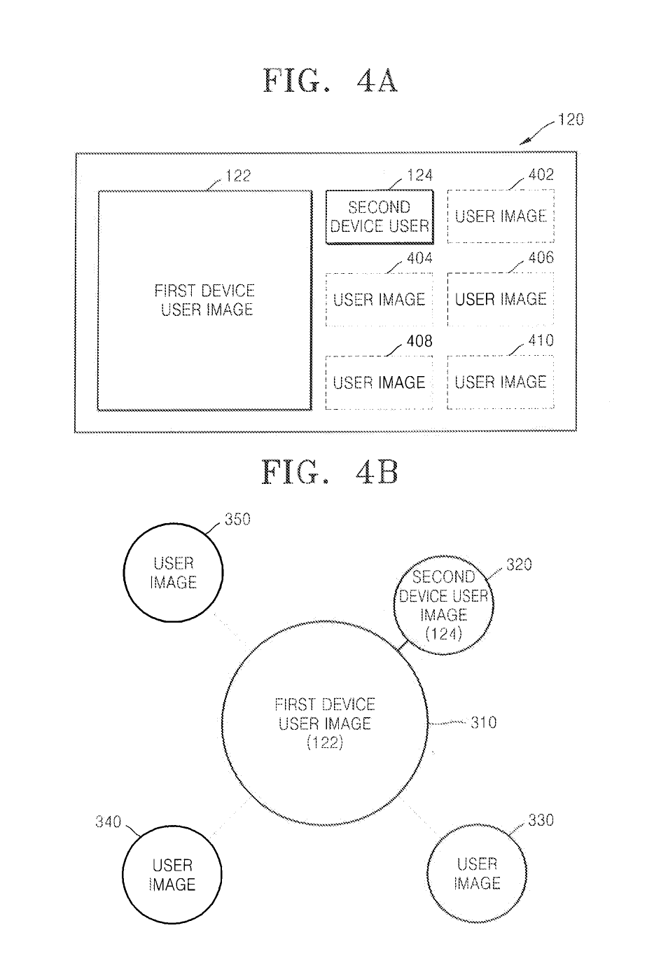

The display unit 120 may display the real-time image information of the user of the second device 200 only. Alternatively, the display unit 120 may display the real-time image information of the user of the first device 100, which is received from the imaging unit 150, as illustrated in FIG. 2, of the first device 100, in addition to the real-time image information of the user of the second device 200. According to FIG. 1, in order to authenticate the user of the second device 200 and to be authenticated by the second device 200, the real-time information of the user of the first device 100 needs to be transmitted to the second device 200. In order to verify that the proper image was transmitted, the real-time information of the user of the second device 200 and the real-time information of the user of the first device 100 may be displayed together by the display unit 120 of the first device 100 in various ways, as described below with reference to FIGS. 2 and 4.

The user of the first device 100 may determine authentication information about the user of the second device 200, based on the real-time image information of the user of the second device 200, which is displayed on the display unit 120 of the first device 100. That is, the user of the first device 100 may authenticate the user of the second device 200, may postpone the authentication, or may reject the authentication. The user input unit 130 may receive the authentication information from the user of the first device 100.

The authentication unit 140 authenticates the user of the second device 200, based on the authentication information received by the user input unit 130. When the user of the second device 200 is authenticated, the authentication unit 140 may grant the user of the second device 200 a data access right or privilege to the first device 100, may authorize a remote control right or privilege to the user of the second device 200, or may allow the real-time image of the user of the first device 100 to be transmitted to the second device 200. When the authentication of the user of the second device 200 is postponed, the user of the second device 200 may be maintained in an authentication “wait state” for a predetermined period of time. When the authentication of the user of the second device 200 is rejected, connection between the first device 100 and the second device 200 may be terminated or connection of the second device 200 to the first device 100 may be blocked.

The authentication of the user of the second device 200 may include a manual authentication or an automatic authentication. The manual authentication may occur when the user of the first device 100 sees the face of the user of the second device 200 displayed on the display unit 120, and then inputs an “access granted” authentication command into the user input unit 130 if the user of the first device 100 authorizes the user of the second device 200 to be connected to the first device 100 via P2P. However, if the user of the first device 100 does not authorize the user of the second device 200 to be connected to the first device 100 via P2P, then the user of the first device 100 may input an “access denied” authentication command into the user input unit 130 after seeing the face of the user of the second device 200 displayed on the display unit 120. The automatic authentication of the user of the second device 200 may include the first device 100 to automatically authenticate the user of the second device 200 by utilizing face recognition software or a face database such as a police criminal database, but is not limited thereto.

Thus, according to FIG. 1, the first device 100 may authenticate the user of the second device 200, based on the real-time image information of the user of the second device 200.

FIG. 2 is a block diagram illustrating the first device 100 to receive the real-time image information of the user of the second device 200 and to authenticate the user of the second device 200, according to an exemplary embodiment of the present general inventive concept. The functions of the first device 100 and the second device 200 of FIG. 1 are applied to the first device 100 and the second device 200 of FIG. 2, and thus will not be repeated herein.

The communication unit 110 of the first device 100 receives the real-time image information of the user of the second device 200. The real-time image information may be obtained from the imaging unit 250 and may be transmitted from a communication unit 210 of the second device 200. According to FIG. 2, a second device user image 222 displayed on a display unit 220 of the second device 200 and a second device user image 124 displayed on the display unit 120 of the first device 100 may be included in image information obtained from the imaging unit 250, and may include the same image information along with additional information such as image size or image position. The user of the first device 100 may input authentication information about the second device 200 through an input unit 130, based on the second device user image 124 displayed on the display unit 120. The authentication unit 140 may authenticate the user of the second device 200, based on the input authentication information.

According to FIG. 2, the authentication unit 140 may notify the communication unit 110 of the first device 100 about an authentication result of the user of the second device 200. Then, the communication unit 110 may allow the second device 200 to access a storage unit 160. Thus, the user of the second device 200 may be allowed to access the storage unit 160 of the first device 100, for example, a hard disk drive (HDD), a particular public folder, etc. As another example of the authentication result, the real-time image of the user of the first device 100 may be transmitted to the second device 200. In addition, as an authentication result of the user of the second device 200, when the authentication is rejected, the connection with the first device 100 may be terminated.

According to another embodiment of the present general inventive concept, the first device 100 may include an imaging unit 150. The first device 100 may obtain the real-time image information of the user of the first device 100 and may transmit the obtained real-time image information to the second device 200 through the communication unit 110. The user of the first device 100 may authenticate the user of the second device 200 and simultaneously may be authenticated by the user of the second device 200, thereby completing mutual authentication. That is, when the user of the second device 200 that accesses the first device 100 is authenticated, the first device 100 does not have to include the imaging unit 150. However, when the user of the first device 100 is authenticated by the user of the second device 200 while authenticating the user of the second device 200, the first device 100 may include the imaging unit 150.

FIG. 3 is a structural diagram illustrating a method of performing user authentication on a plurality of devices connected to the first device 100, according to an exemplary embodiment of the present general inventive concept.

Referring to FIG. 3, a plurality of devices including the second device 200 may be connected to the first device 100 through a network. Accordingly, even in an environment without infrastructure such as an access point (AP) or similar infrastructure, a network may be configured so as to connect the first device 100 to at least one other device by using a software enabled access point (Soft-AP) provided from an operating system (OS) such as Windows® 7 or similar platform. However, when devices are connected by using Soft-AP, the number of connectable devices is limited by the OS or by an application supporting the Soft-AP.

An authentication mechanism of wireless Internet technologies is based on a IEEE 802.1x standard. The authentication mechanism provides port-based access control and provides mutual authentication between a client and an AP through an authentication server.

A 802.1x authentication method provides access control in wireless Internet and a wireless LAN environment and facilitates access to a backbone network through an AP on the IEEE 802.11 architecture. Since the 802.1x authentication method is based on a server to manage authentication information, an environment where an AP and an authentication server always exist, and a database (DB) to manage the authentication information are required.

However, according to the above-described exemplary embodiment of the present general inventive concept, it may be possible to authenticate a user by connecting a plurality of devices of users without an authentication management server using Soft-AP. In other words, the first device 100 can connect to each of the second device 200, a device A 310, a device B 320, . . . , and a device N 330 with authenticated users but without a need for an authentication management server as an intermediate device between the first and second devices for authentication.

According to another exemplary embodiment of the present general inventive concept, the communication unit 110 of the first device 100 may set a channel to connect at least one device, may select the same channel as a channel set in the first device 100, and may perform user authentication on a plurality of devices connected to the first device 100. Accordingly, real-time image information about users of a plurality of users may be displayed on the display unit 120 of the first device 100, as illustrated in FIGS. 4A and 4B.

FIG. 4A is a diagram illustrating real-time image information received from a plurality of devices being displayed on a display unit, according to an exemplary embodiment of the present general inventive concept.

Referring to FIGS. 2 and 4A, a first device user image 122 may be displayed on a left part of the display unit 120. Real-time image information of users of other devices (i.e., second device user 124, and user images 402, 404, 406, 408, and 410) may be displayed on right portions of the display unit 120 that are previously divided or are divided according to the number of devices connected to the first device 100. The displayed real-time image information of the users of the devices may include a user profile or an authentication state (e.g., whether authentication is already performed, whether authentication is postponed, etc.). For example, an authenticated state may be indicated by a solid line and an authentication-wait state, an authentication-postpone state, or an authentication-rejection state may be indicated by using other methods.

FIG. 4B is a diagram illustrating real-time image information received from a plurality of devices being displayed on a display unit, according to another exemplary embodiment of the present general inventive concept.

Referring to FIGS. 2 and 4B, the first device user image 122 is positioned in a central circle 310. When other devices of users to be authenticated are connected to the first device 100, real-time user images of the other devices connected to the first device 100 may be displayed in small circles 320, 330, 340, and 350, respectively around the central circle 310. If a user of a second device 200 is connected or authenticated, a second device user image 124 may be displayed adjacent to the central circle 310 in order to be distinguished from other user images that are not connected or authenticated. The user of the first device 100 may easily transmit a file by dragging and dropping the file to a circle of the user of the first device 100 that is displayed to be authenticated. In addition, the user of the first device 100 may also receive a file from a user that is completely authenticated.

FIGS. 4A and 4B illustrate real-time image information being displayed on a display unit 120 and/or 220. The arrangement and use of the displayed real-time image information may be changed in various ways.

Through structures of FIGS. 4A and 4B differ, the user of the first device 100 may easily recognize information about a real-time user image and authentication of a plurality of users that access the first device 100 and may intuitionally transmit and receive a data file.

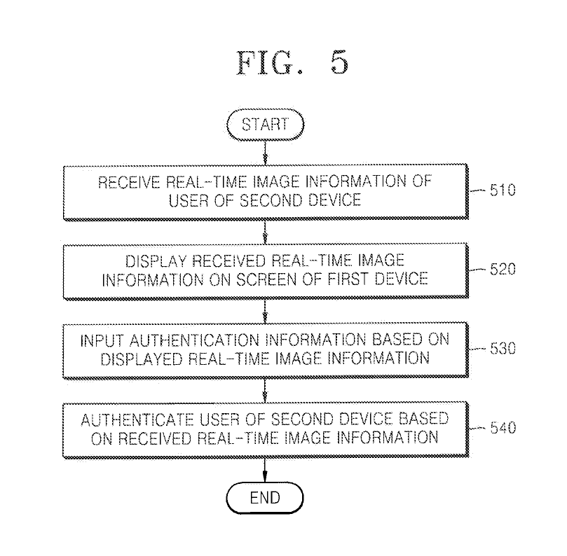

FIG. 5 is a flowchart of a user authentication method according to an exemplary embodiment of the present general inventive concept. Referring to FIG. 5, the user authentication method may include operations that are performed in time sequence by components of the first device 100 and the second device 200 of FIGS. 1, 4A, and 4B. Thus, although omitted, the details of the user authentication apparatus of FIGS. 1, 4A, and 4B may also be applied to the user authentication method of FIG. 5.

Referring to FIG. 5, in operation 510, the first device 100 receives real-time image information containing an image corresponding to a face of a user of the second device 200 from the second device 200. In operation 520, the display unit 120 displays the received real-time image information on a display screen of the first device 100. In operation 530, the input unit 130 receives user authentication information to determine whether a user of the second device 200 is authenticated with reference to the displayed real-time image information, from the user of the first device 100. In operation 540, the authentication unit 140 authenticates the user of the second device 200, based on the received user authentication information.

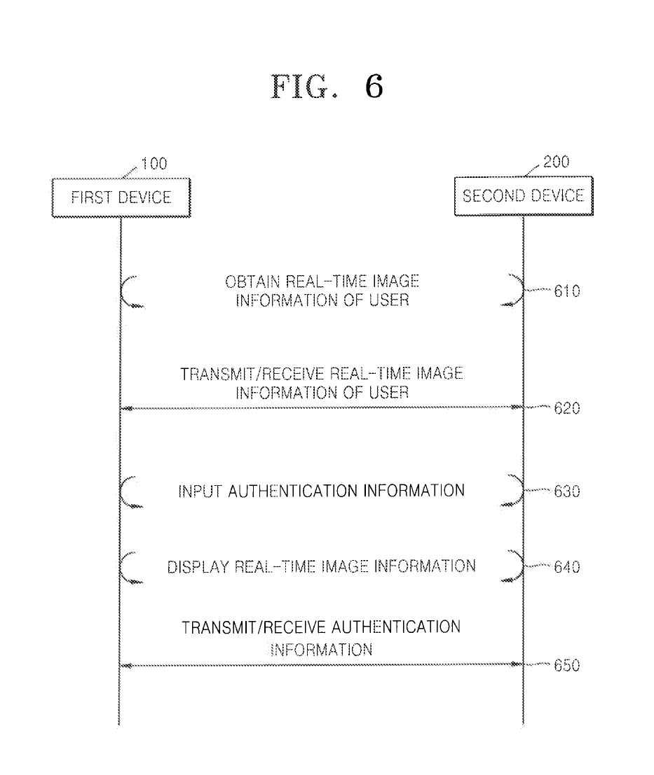

FIG. 6 is a diagram illustrating mutual authentication as a user authentication method, according to another exemplary embodiment of the present general inventive concept. Referring to FIG. 6, the mutual authentication may include operations that are performed in time sequence by components of the first device 100 and the second device 200 of FIGS. 1, 4A, and 4B, respectively. Thus, although omitted, the details of the user authentication apparatus of FIGS. 1, 4A, and 4B may also be applied to the mutual authentication of FIG. 6.

Referring to FIG. 6, operations included in the mutual authentication in terms of the first device 100 will be described. In operation 610, the imaging unit 150 of the first device 100 obtains real-time image information of the user of the first device 100. In operation 620, the first device 100 transmits the real-time image information to the second device 200 and receives real-time image information of the user of the second device 200 from the second device 200. In operation 630, the display unit 120 simultaneously displays the real-time image information of the user of the second device 200 and the real-time image information of the user of the first device 100. In operation 640, the input unit 140 receives user authentication information to determine whether the user of the second device 200 is authenticated based on the displayed real-time image information, from the user of the first device 100.

The same operations 610 through 640 as in the first device 100 are also performed in the second device 200. The communication unit 110 transmits the user authentication information of the second device 200, which is received by the first device 100, and receives authentication information containing information about whether the user of the first device 100 is authenticated, from the second device 200. Finally, in operation 650, mutual authentication may be performed based on the transmitted user authentication information and the user authentication information received from the second device 200.

As discussed above, FIGS. 5 and 6 have been described as methods. However, it will be understood by those of ordinary skill in the art that FIGS. 5 and 6 may also be applied to an apparatus according to an exemplary embodiment of the present general inventive concept.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can generate or transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, a user may perform mutual authentication between a plurality of devices by using a real-time image stream method when a network is formed directly between the plurality of devices in an environment without a predefined infrastructure based on an authentication server. Thus, another user may be identified without using an authentication server.

In addition, authentication according to the above-described embodiments of the present general inventive concept is performed on a user of a device through a real-time image, thereby preventing an unauthorized user without any access rights or privileges from harming the authorized user possessing access rights or privileges if the unauthorized user attempts to use the authentication information of the device when the device is stolen, lost, or misappropriated.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of authenticating a user of a second device connected to a first device peer-to-peer (P2P) on a network, the method comprising:
receiving from the second device real-time image information containing a face of the user of the second device;
displaying the received real-time image information on a screen of the first device;
receiving from a user of the first device user authentication information to determine whether the user of the second device is authenticated with reference to the displayed real-time image information; and
authenticating the user of the second device, based on the received user authentication information.

2. The method of claim 1, further comprising:
obtaining real-time image information containing a face of the user of the first device; and
transmitting the obtained real-time image information to the second device,
wherein the displaying comprises displaying the real-time image information and the obtained real-time image information.

3. The method of claim 1, wherein the first device is connected to at least one device, and the second device is any one of devices connected to the first device.

4. The method of claim 1, wherein the real-time image information of the second device is received by using a streaming method.

5. The method of claim 1, wherein the first device is connected to the second device by using a software enabled access point (Soft-AP).

6. The method of claim 1, further comprising:
transmitting and receiving a file based on the authenticating.

7. A first device connected to a second device peer-to-peer (P2P) on a network, the first device comprising:
a communication unit to receive from the second device real-time image information containing a face of a user of the second device;
a display unit to display the received real-time image information;
an input unit to receive from a user of the first device user authentication information to determine whether the user of the second device is authenticated with reference to the displayed real-time image information; and
a user authentication unit to authenticate the user of the second device, based on the received user authentication information.

8. The first device of claim 7, further comprising:
an imaging unit to obtain real-time image information containing a face of a user of the first device, wherein
the communication unit transmits the obtained real-time image information to the second device, and
the display unit simultaneously displays the received real-time image information and the obtained real-time image information.

9. The first device of claim 7, wherein the first device is connectable to at least one device, and the second device is one connected to the first device.

10. The first device of claim 7, wherein the real-time image information of the second device is received by using a streaming method.

11. The first device of claim 7, wherein the first device is connected to the second device by using a software enabled access point (Soft-AP).

12. The first device of claim 7, further comprising:
a storage unit to manage receipt and transmission of a file, based on the authenticating.

13. A mutual authentication method of a user of a first device and a user of a second device that are connected peer-to-peer (P2P) through a connection channel on a network, the mutual authentication method comprising:
obtaining real-time image information of the user of the first device and transmitting the obtained real-time image information to the second device;
receiving from the second device real-time image information of the second device;
simultaneously displaying the received real-time image information and the obtained real-time image information;
receiving user authentication information to determine whether the user of the second device is authenticated based on the displayed real-time image information;
receiving from the second device user authentication information to determine whether the user of the first device is authenticated; and
performing mutual authentication, based on the received user authentication information and the received user authentication information.

14. A non-transitory computer readable recording medium having recorded thereon a program to execute a method of authenticating a user of a second device connected to a first device peer-to-peer (P2P) on a network, the method comprising:
receiving from the second device real-time image information containing a face of the user of the second device;
displaying the received real-time image information on a screen of the first device;
receiving from a user of the first device user authentication information to determine whether the user of the second device is authenticated with reference to the displayed real-time image information; and
authenticating the user of the second device, based on the received user authentication information.

15. A non-transitory computer readable recording medium having recorded thereon a program to execute a mutual authentication method of a user of a first device and a user of a second device that are connected peer-to-peer (P2P) through a connection channel on a network, the mutual authentication method comprising:
obtaining real-time image information of the user of the first device and transmitting the obtained real-time image information to the second device;
receiving from the second device real-time image information of the second device;
simultaneously displaying the received real-time image information and the obtained real-time image information;
receiving user authentication information for determining whether the user of the second device is authenticated based on the displayed real-time image information;
receiving from the second device user authentication information to determine whether the user of the first device is authenticated; and
performing mutual authentication, based on the received user authentication information and the received user authentication information.

16. A peer-to-peer (P2P) network device connectable to one or more devices, comprising:
a communication unit to receive real-time image information from the one or more devices;
a display unit to display the received real-time image information; and
a user authentication unit to authenticate a user corresponding one or more devices based on the received real-time image information.

17. The P2P network device of claim 16, wherein each device further comprises:
an input unit to receive user authentication information from the user based on whether the received real-time image information authenticated.

18. The P2P network device of claim 16, wherein the display unit displays real time image information corresponding to the user simultaneously with the real-time image information corresponding to another user.

19. The P2P network device of claim 16, wherein each device further comprises:
an imaging unit to obtain the real-time image information corresponding to the user using the respective device, such that the communication unit transmits the obtained real-time image information to another of the plurality of devices.

20. The P2P network device of claim 16, wherein the communication unit communicates with the one or more devices such that the one or more devices takes a real-time user image to be transferred to the communication unit.

21. The P2P network device of claim 16, wherein each device comprises one of a computer apparatus, a laptop computer, a mobile device, and a touchpad.

22. The P2P network device of claim 16, wherein the real-time image information corresponds to an image of at least a portion of the user.
